(19) United States
(12) Patent Application Publication
(10) Pub. No.: US 2026/0279227 A1
(43) Pub. Date: Sep. 17, 2026

(54) Piggyback Replacement Label

(71) Applicant: Iconex LLC, Atlanta, GA (US)

(72) Inventors: Timothy Darren Livingston, Carryton, TN (US); Chase Nathaniel Perritt, Duluth, GA (US)

(21) Appl. No.: 19/561,086

(22) Filed: Mar. 9, 2026

Related U.S. Application Data
(60) Provisional application No. 63/770,713, filed on Mar. 12, 2025.

(51) Int. Cl. G09F 3/00; G09F 3/02; G09F 3/10

(52) U.S. Cl. CPC G09F 3/0286; G09F 3/0288; G09F 3/10; G09F 2003/0229; G09F 2003/0267

(57) ABSTRACT

A roll of labels is provided comprising a liner substrate and a plurality of label substrates, each having a backside flood coated with a repositionable high tack adhesive. The liner substrate includes at least one triangular or half circular liner die cut positioned at a corner or center edge of each label substrate. For piggyback labels, each label substrate includes a label die cut defining a removable inner label. When a label substrate is separated from the liner substrate by an auto applicator peel bar, the liner die cut creates a small, manageable hole in the liner waste, maintaining structural integrity during rewinding. Repositionable high tack adhesive ensures sufficient adhesion to a packaging surface while enabling clean removal of the removable inner label after application, the removable inner label retaining adhesive on its backside for re-adhesion to a secondary surface. A method of manufacturing such label rolls is also provided.

### RELATED APPLICATIONS

The current application is a non-provisional of U.S. Provisional App. No. 63/770,713 filed on Mar. 12, 2025, entitled “Piggyback Replacement Label;” the disclosure of which in its entirety is incorporated by reference herein.

### BACKGROUND

Conventional piggyback labels often present challenges in automated application environments. The separation of labels from liners by auto applicator peel bars can be inconsistent, and waste liner rewinding frequently results in jams due to structural weaknesses created by die cuts or holes in the waste liner. Additionally, specialized adhesive formulations may require complex drying processes during manufacturing, increasing production costs and time. These issues can lead to inefficient label application, equipment downtime, and compromised label functionality. Conventional liner die cut configurations, such as large rectangular or circular cutouts, can weaken the liner substrate to a degree that causes tearing during high-speed rewinding operations. Furthermore, conventional piggyback label constructions may employ aggressive permanent adhesives that make separation of the inner piggyback label from the primary label difficult or that damage the surface to which the primary label is applied. A need therefore exists for piggyback labels that maintain structural integrity during auto application while ensuring reliable and clean separation of both the primary label from the liner and the piggyback label from the primary label once applied to packaging, without requiring specialized adhesive drying equipment or processes during manufacturing.

### SUMMARY

A roll of labels is provided comprising a liner substrate and at least one label substrate adhered to the liner substrate. A backside of the label substrate is flood coated with a repositionable high tack adhesive. The liner substrate includes at least one liner die cut positioned at a corner of the label substrate or at a center edge of a removable inner label of the label substrate. The liner die cut is configured to create a small, manageable hole in the liner substrate upon separation of the label substrate from the liner substrate by an auto applicator peel bar, thereby maintaining the structural integrity of the liner waste during rewinding. In embodiments directed to piggyback replacement labels, the label substrate further includes a label die cut defining a removable inner label within the label substrate. The repositionable high tack adhesive enables reliable adhesion of the label substrate to a packaging surface while permitting clean separation of the inner label from the primary label when needed. This configuration eliminates the need for specialized adhesive drying processes and improves overall performance in automated label application environments.

### BRIEF DESCRIPTION OF THE DRAWINGS

FIG. 1 is a diagram illustrating a roll of piggyback replacement labels, according to an example embodiment.

FIG. 2 is a diagram illustrating another roll of piggyback replacement labels, according to an example embodiment.

FIG. 3 is a diagram illustrating a roll of labels, according to an example embodiment.

FIG. 4 is a diagram illustrating still another roll of piggyback replacement labels, according to an example embodiment.

FIG. 5 is a diagram of a method for manufacturing the rolls of the piggyback replacement labels and labels, according to an example embodiment.

### DETAILED DESCRIPTION

As used herein, the term and phrase “liner” and/or “liner substrate” may be used interchangeably and synonymously. Also, the phrases “face stock,” “label substrate,” and “label” may be used interchangeably and synonymously herein and below. The term “repositionable high tack adhesive” as used herein refers to an adhesive that provides a sufficiently high level of initial tack and adhesion to securely attach a label substrate to a packaging surface or other target surface, while also permitting removal or repositioning of a label or inner label without leaving undesirable adhesive residue or causing damage to the underlying surface. The term “liner die cut” as used herein refers to a die cut formed through the liner substrate that does not extend through the label substrate adhered thereto. The term “label die cut” as used herein refers to a die cut formed through the label substrate that defines the boundary of a removable inner label, also referred to herein as a piggyback label, within the label substrate. The term “flood coat” or “flood coated” as used herein refers to the application of a continuous, uniform layer of adhesive across the entire backside surface area of the label substrate, as distinguished from pattern coating or spot coating in which adhesive is applied only to selected regions of the backside of the label substrate.

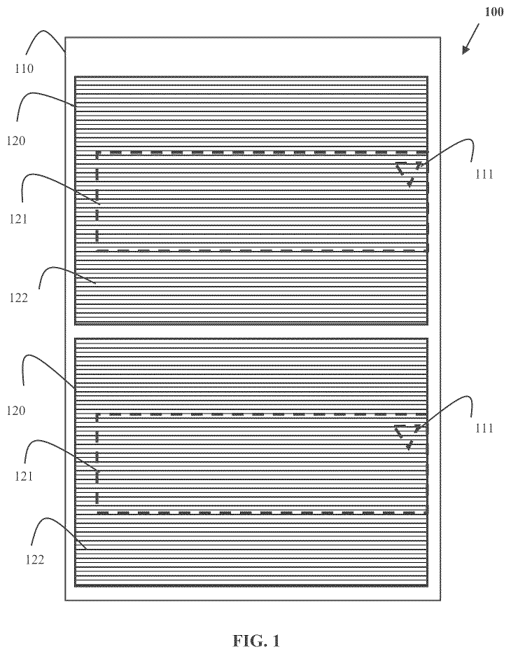

FIG. 1 is a diagram illustrating a roll 100 of piggyback replacement labels, according to an example embodiment. The roll 100 includes a liner substrate 110 and a plurality of label substrates 120 adhered to the liner substrate 110. Each label substrate 120 includes an inner label 121 defined by a die cut within the label substrate 120. The backside of each label substrate 120 is coated with a repositionable high tack adhesive 122, which may be a repositionable hot melt adhesive or a rubber-based acrylic adhesive. The repositionable high tack adhesive 122 is flood coated across the entire backside of the label substrate 120. The flood coating of the repositionable high tack adhesive 122 across the entire backside of the label substrate 120 ensures uniform adhesion between the label substrate 120 and the liner substrate 110, and between the label substrate 120 and the packaging surface upon application, while eliminating the need for selective or pattern adhesive application processes that require additional drying or curing equipment.

The liner substrate 110 includes at least one liner die cut 111 positioned at a corner of each label substrate 120. In the embodiment shown in FIG. 1, a single triangular die cut 111 is positioned at one corner of each label substrate 120. The triangular die cut 111 is oriented so that the apex of the triangle points inward toward a center of the label substrate 120, and the base of the triangle aligns with the outer edge of the liner substrate 110 at the corner of the label substrate 120. When an auto applicator separates a label substrate 120 from the liner substrate 110, the triangular die cut 111 creates a small and manageable hole in the liner waste, maintaining the structural integrity of the liner substrate 110 during rewinding by the auto applicator. The small size and geometric configuration of the triangular die cut 111 limits the reduction of cross-sectional liner material to a minimal area, thereby preserving the tensile strength of the liner waste web sufficient to withstand the tension imposed during high-speed rewinding operations. Because the liner die cut 111 does not penetrate the label substrate 120, the label substrate 120 remains fully intact and the printable front side surface of the label substrate 120 is unaffected by the liner die cut 111.

In an embodiment, the liner substrate 110 is constructed from a paper-based material, a polymeric film material, or a combination thereof. The liner substrate 110 has a basis weight and caliper selected to provide sufficient stiffness and tensile strength to withstand the forces of automated label dispensing and liner waste rewinding. The liner die cuts 111 are formed through the full thickness of the liner substrate 110 without penetrating the label substrate 120, such that the label substrate 120 remains intact and printable across its entire face.

The inner label 121, defined by a die cut in the label substrate 120, functions as a piggyback label that can be removed from the main or primary label after the main label has been applied to a package or other surface. The repositionable high tack adhesive 122 provides sufficient adhesion to securely attach the label substrate 120 to a package while also enabling easy and clean separation of the inner label 121 from the main label when needed. Because the repositionable high tack adhesive 122 is flood coated across the entire backside of the label substrate 120, including the area underlying the inner label 121, the inner label 121 retains adhesive on its backside upon removal, enabling the inner label 121 to be re-adhered to a secondary surface such as a document, envelope, or other package. The repositionable characteristic of the adhesive 122 permits such re-adhesion without permanent bonding, allowing the inner label 121 to be repositioned if needed.

The triangular die cut 111 provides several advantages over conventional die cut shapes. The triangular shape creates a clean separation point while minimizing the size of the hole created in the liner waste. This maintains the structural integrity of the liner waste during rewinding by the auto applicator, reducing the likelihood of jams and equipment downtime.

In an embodiment, a front side of the liner substrate 110 includes a release coating. The release coating facilitates clean and consistent release of the label substrate 120 from the liner substrate 110 during automated dispensing, ensuring that the repositionable high tack adhesive 122 releases from the liner substrate 110 at a controlled and repeatable peel force. In an embodiment, the release coating is a water-based release coating. In an embodiment, the release coating is a silicone-based release coating. The selection of the release coating type may be based on compatibility with the repositionable high tack adhesive 122 and the requirements of the specific auto applicator equipment used.

In an embodiment, the front side of the label substrates 120 and inner removable labels 121 includes a thermal sensitive print or image coating or a thermal receptive print or image coating. The thermal receptive coating enables direct thermal printing of variable information, such as shipping addresses, barcodes, tracking numbers, or other data, onto the front side of the label substrate 120 and inner label 121 using a direct thermal print head, without requiring a separate ink ribbon. This feature makes the piggyback replacement labels of the present disclosure compatible with standard direct thermal label printers commonly used in shipping, logistics, and retail environments.

In an embodiment, the label substrate 120 is constructed from a paper-based material, a polymeric film material, or a combination thereof. The liner substrate 110 has a basis weight and caliper selected to provide sufficient stiffness and tensile strength to withstand the forces of automated label dispensing and liner waste rewinding at the operating speeds of the auto applicator equipment for which the roll 100 is designed. In an embodiment, the label substrate 120 has a caliper and face stock composition selected to be compatible with direct thermal printing equipment, including direct thermal printers commonly used in shipping, logistics, and warehousing environments.

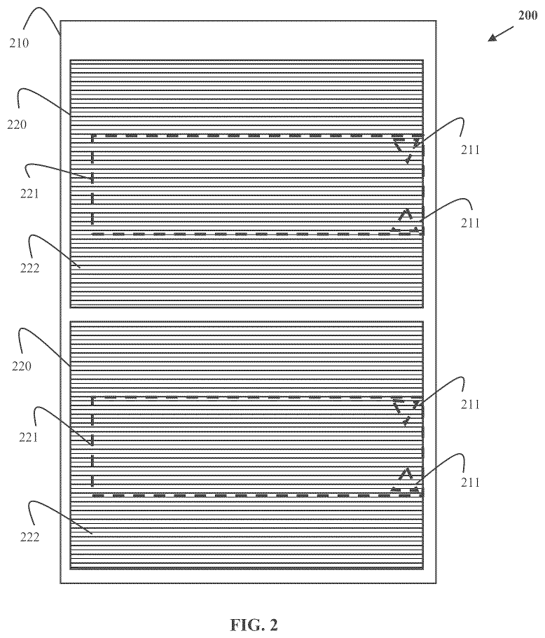

FIG. 2 is a diagram illustrating another embodiment of a roll 200 of piggyback replacement labels, according to an example embodiment. The roll 200 includes a liner substrate 210 and a plurality of label substrates 220 adhered to the liner substrate 210. Each label substrate 220 includes an inner label 221 defined by a die cut within the label substrate 220. The backside of each label substrate 220 is coated with a repositionable high tack adhesive 222.

The liner substrate 210 includes two liner die cuts 211 positioned at opposite corners of each label substrate 220. The two triangular die cuts 211 provide improved stability of the liner waste during rewinding by the auto applicator while still enabling efficient separation of the label substrate 220 from the liner substrate 210 by the peel bar of the auto applicator.

The configuration with two triangular die cuts 211 at opposite corners provides balanced separation forces when the label substrate 220 is pulled from the liner substrate 210 by the auto applicator's peel bar. This balanced configuration reduces the likelihood of tearing or uneven separation while still maintaining sufficient liner waste integrity.

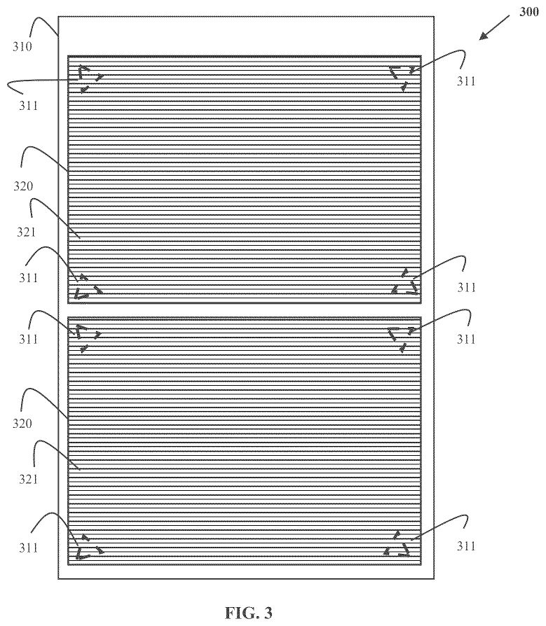

FIG. 3 is a diagram illustrating a roll 300 of labels that do not include piggyback functionality, according to an example embodiment. The roll 300 includes a liner substrate 310 and a plurality of label substrates 320 adhered to the liner substrate 310. The backside of each label substrate 320 is coated with a repositionable high tack adhesive 321. The absence of a label die cut in the label substrates 320 of this embodiment means that each label substrate 320 functions as a single unitary label without a removable inner label component. This configuration is suitable for applications in which a replacement or secondary label functionality is not required, but in which the benefits of the repositionable high tack adhesive 321 and the liner die cuts 311 for improved auto application performance are desired.

In an embodiment, the label substrate 320 of roll 300 is coated on its backside with the repositionable high tack adhesive 321 in a flood coat manner, consistent with the other embodiments described herein. The repositionable high tack adhesive 321 provides sufficient adhesion to a packaging surface while allowing for repositioning of the label substrate 320 during application if needed. The liner substrate 310 in this embodiment similarly includes a front side release coating to facilitate consistent peel force during automated dispensing.

The liner substrate 310 includes four liner die cuts 311 positioned at each corner of each label substrate 320. While FIG. 3 illustrates four liner die cuts 311, it should be understood that any number of liner die cuts may be used, such as one, two, or three, depending on the specific application requirements. The triangular die cuts 311 enable efficient separation of the label substrate 320 from the liner substrate 310 by the peel bar of the auto applicator while maintaining the structural integrity of the liner waste during rewinding. Each of the four triangular die cuts 311 is oriented with the apex pointing inward toward a center of the label substrate 320 and the base aligned with the outer edge of the liner substrate 310 at the respective corner of the label substrate 320, consistent with the triangular die cut orientation described with respect to the embodiment of FIG. 1.

The configuration with four triangular die cuts 311 at each corner provides maximum stability and balanced separation forces when the label substrate 320 is pulled from the liner substrate 310. This arrangement distributes separation forces evenly across all corners of the label, virtually eliminating the risk of tearing or uneven separation. The strategic placement of these triangular die cuts ensures that the liner waste maintains optimal structural integrity during rewinding by the auto applicator, while still creating only small, manageable holes that don't compromise the overall strength of the liner 310. This configuration is particularly beneficial for applications requiring the highest level of reliability in the auto application process.

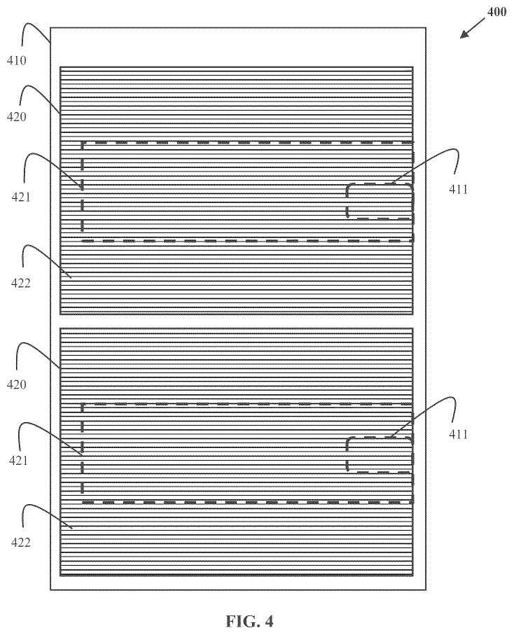

FIG. 4 is a diagram illustrating another embodiment of a roll 400 of piggyback replacement labels, according to an example embodiment. The roll 400 includes a liner substrate 410 and a plurality of label substrates 420 adhered to the liner substrate 410. Each label substrate 420 includes an inner label 421 defined by a die cut within the label substrate 420. The backside of each label substrate 420 is coated with a repositionable high tack adhesive 422.

The liner substrate 410 includes liner die cuts 411 positioned at center edges of each label substrate 420. In an embodiment, the liner die cuts 411 are positioned at the center edge of the removable inner label 421 defined by the label die cut within the label substrate 420. This positioning allows the die cut 411 to function as an initiation point for separation of the inner label 421 from the primary label when the user begins to peel the inner label 421 away from the primary label after the primary label has been applied to a package or other surface. In an embodiment, the liner die cuts 411 are half circular shapes. The center edge positioning of the liner die cuts 411 provides an alternative arrangement that balances the need for efficient separation of the label substrate 420 from the liner substrate 410 with the requirement to maintain structural integrity of the liner waste during rewinding by the auto applicator. In an embodiment, the liner substrate 410 includes a single half circular die cut 411 positioned at the center edge of the removable inner label 421. In another embodiment, the liner substrate 410 includes two half circular die cuts 411 positioned at opposite center edges of the removable inner label 421, providing a balanced initiation profile for peeling the inner label 421 from the primary label substrate 420 and distributing the initial separation force more evenly across the liner waste.

In an embodiment, the half circular liner die cut 411 is oriented so that the flat edge of the half circle is aligned with the center edge of the inner label 421, and the curved portion of the half circle extends into the liner substrate 410 beneath the inner label 421. This orientation creates a smooth, arcuate separation initiation point along the center edge of the inner label 421 that reduces stress concentrations and provides a tactile lifting point for a user to begin peeling the inner label 421 from the primary label substrate 420.

The half circular shape of liner die cuts 411 provides a smooth separation profile when the label substrate 420 is separated from the liner substrate 410. This shape distributes separation forces evenly along the curved edge, reducing stress concentration points that could lead to tearing or uneven separation.

In an embodiment, the number and placement of liner die cuts 411 in the liner substrate 410 are selected based on the size of the removable inner label 421, the peel force characteristics of the repositionable high tack adhesive 422, and the operating speed and peel bar geometry of the auto applicator. Larger inner labels 421 or higher tack adhesive formulations may benefit from two half circular die cuts 411 positioned at opposite center edges of the removable inner label 421 to distribute the initial separation force over a greater area of the liner waste and to provide a more consistent and repeatable separation initiation profile during automated dispensing.

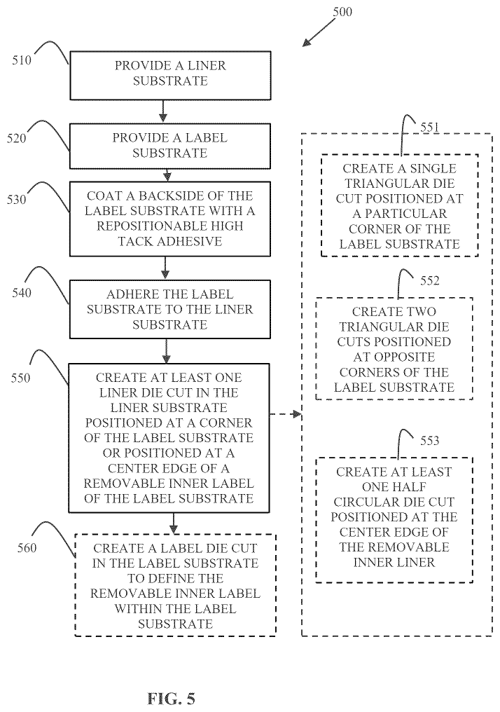

FIG. 5 is a diagram of a method 500 for manufacturing the rolls of piggyback replacement labels and labels, according to an example embodiment. The method 500 is processed by a press at one or more stations, with the electro-mechanical components of the press controlled by firmware or software. The press may be a web-fed rotary press or a flatbed press configured to handle continuous rolls of liner substrate and label substrate materials. The method 500 enables production of label rolls having various configurations of liner die cuts and, optionally, label die cuts, as described in the embodiments above.

At 510, a station of the press is provided or receives a liner substrate for a liner. At 520, the station of the press provides or receives a label substrate for a label.

At 530, the station of the press coats a backside of the label substrate with a repositionable high tack adhesive. At 540, the station of the press adheres the label substrate to the liner substrate.

At 550, the station of the press creates at least one liner die cut in the liner substrate positioned at a corner of the label substrate or positioned at a center edge of a removable inner label of the label substrate. The liner die cut is formed through the full thickness of the liner substrate without cutting through the label substrate, such that the label substrate remains intact and its printable front side surface is unaffected by the liner die cut formation step. In an embodiment, at 551, the station of the press creates a single triangular die cut positioned at a particular corner of the label substrate, the triangular die cut oriented with an apex pointing inward toward a center of the label substrate and a base of the triangular die cut aligned with the outer edge of the liner substrate at that corner. In an embodiment, at 552, the station of the press creates two triangular die cuts positioned at opposite corners of the label substrate. In an embodiment, at 553, the station of the press creates at least one half circular die cut positioned at the center edge of the removable inner label, the half circular die cut oriented with a flat edge aligned with the center edge of the removable inner label and a curved portion extending into the liner substrate beneath the removable inner label. In an embodiment in which four triangular die cuts are desired, the station of the press creates a triangular die cut at each of the four corners of the label substrate, each triangular die cut oriented with the apex pointing inward toward the center of the label substrate and the base aligned with the outer edge of the liner substrate at the respective corner.

In an embodiment, at 560, the station of the press creates a label die cut in the label substrate to define the removable inner label within the label substrate.

The method 500 can be adapted to produce various configurations of labels and piggyback labels by adjusting the number, position, and shape of the liner die cuts. This versatility allows manufacturers to optimize the label design for specific auto applicator equipment and application requirements while maintaining the benefits of improved liner waste integrity and reliable label separation. The method 500 further eliminates the need for specialized adhesive drying or curing equipment by utilizing repositionable high tack adhesives that are compatible with standard web-fed press coating and laminating processes. The resulting label rolls are compatible with standard auto applicator equipment and direct thermal printers, making the piggyback replacement labels of the present disclosure a drop-in replacement for conventional piggyback label constructions.

In an embodiment, the press performing method 500 includes a coating station configured to apply the repositionable high tack adhesive to the backside of the label substrate in a flood coat manner using a gravure coater, a slot die coater, or a roll coater. The coating weight of the repositionable high tack adhesive is selected to provide a target peel adhesion value sufficient to maintain adhesion of the label substrate to a packaging surface under expected handling and environmental conditions, while maintaining the repositionable characteristic that enables clean separation of the inner label from the primary label.

In an embodiment, the liner substrate and label substrate used in method 500 are provided as continuous webs on supply rolls. After completion of all coating, laminating, and die cutting steps, the finished roll of piggyback replacement labels or labels is wound onto a take-up core to form the roll configurations illustrated in FIGS. 1-4. The finished rolls are compatible with standard auto applicator equipment that uses a peel bar to separate individual label substrates from the liner substrate during application to packages.

In an embodiment, the repositionable high tack adhesive applied at step 530 is a repositionable hot melt adhesive or a rubber-based acrylic adhesive selected to provide a peel adhesion force sufficient to maintain adhesion of the label substrate to a packaging surface under handling and environmental conditions expected during shipping and distribution, while retaining the repositionable characteristic that permits clean separation of the removable inner label from the primary label without adhesive residue transfer to the primary label surface or the packaging surface. The adhesive formulation is compatible with standard web-fed press coating equipment, including gravure coaters, slot die coaters, and roll coaters, eliminating the need for specialized adhesive drying or curing equipment in the manufacturing process and reducing overall production costs and manufacturing cycle time.

Although the present invention is described with reference to certain preferred embodiments thereof, variations and modifications of the present invention can be affected within the spirit and scope of the following claims.

1. A roll of labels, comprising:
a liner substrate;
a plurality of label substrates adhered to the liner substrate, each label substrate having a backside that is flood coated with a repositionable high tack adhesive; and
at least one liner die cut formed through the liner substrate, the at least one liner die cut positioned at a corner of at least one of the plurality of label substrates or positioned at a center edge of a removable inner label of at least one of the plurality of label substrates;
wherein the at least one liner die cut is configured to create a hole in the liner substrate when a corresponding one of the plurality of label substrates is separated from the liner substrate by an auto applicator peel bar, thereby maintaining structural integrity of the liner substrate during rewinding.

2. The roll of labels of claim 1, wherein the repositionable high tack adhesive comprises a repositionable hot melt adhesive or a rubber-based acrylic adhesive.

3. The roll of labels of claim 1, wherein the at least one liner die cut comprises a triangular shape positioned at the corner of the at least one of the plurality of label substrates or a half circular shape positioned at the center edge of the removable inner label of the at least one of the plurality of label substrates.

4. The roll of labels of claim 1, wherein at least one of the plurality of label substrates includes a label die cut defining the removable inner label within the at least one of the plurality of label substrates, the removable inner label being peelable from the at least one of the plurality of label substrates after the at least one of the plurality of label substrates is applied to a surface.

5. The roll of labels of claim 4, wherein the at least one liner die cut comprises a single triangular die cut positioned at a corner of the at least one of the plurality of label substrates, the single triangular die cut oriented with an apex pointing inward toward a center of the at least one of the plurality of label substrates and a base of the single triangular die cut aligned with an outer edge of the liner substrate at the corner.

6. The roll of labels of claim 4, wherein the at least one liner die cut comprises two triangular die cuts positioned at opposite corners of the at least one of the plurality of label substrates, the two triangular die cuts providing balanced separation forces when the at least one of the plurality of label substrates is separated from the liner substrate by the auto applicator peel bar.

7. The roll of labels of claim 1, wherein the at least one liner die cut comprises four triangular die cuts, each of the four triangular die cuts positioned at a respective corner of the corresponding one of the plurality of label substrates and oriented with an apex pointing inward toward a center of the corresponding one of the plurality of label substrates.

8. The roll of labels of claim 1, wherein the liner substrate includes a release coating on a front side of the liner substrate facing the backside of each of the plurality of label substrates, the release coating providing a controlled and repeatable peel force between the liner substrate and the repositionable high tack adhesive of each of the plurality of label substrates during automated dispensing.

9. The roll of labels of claim 8, wherein the release coating is a water-based release coating or a silicone-based release coating, and wherein a front side of at least one of the plurality of label substrates includes a thermally receptive coating configured to enable direct thermal printing on the front side of the at least one of the plurality of label substrates.

10. A method of manufacturing a roll of labels, comprising:
providing a liner substrate; providing a label substrate; flood coating a backside of the label substrate with a repositionable high tack adhesive; and
adhering the label substrate to the liner substrate; and creating at least one liner die cut through a full thickness of the liner substrate without cutting through the label substrate, the at least one liner die cut positioned at a corner of the label substrate or positioned at a center edge of a removable inner label of the label substrate;
wherein the at least one liner die cut is configured to create a hole in the liner substrate when the label substrate is separated from the liner substrate, thereby maintaining structural integrity of the liner substrate during rewinding by an auto applicator.

11. The method of claim 10, further comprising creating a label die cut in the label substrate to define the removable inner label within the label substrate, the removable inner label being peelable from a remainder of the label substrate after the label substrate is applied to a target surface.

12. The method of claim 10, wherein creating the at least one liner die cut comprises creating a single triangular die cut positioned at a particular corner of the label substrate, the single triangular die cut oriented with an apex pointing inward toward a center of the label substrate and a base of the single triangular die cut aligned with an outer edge of the liner substrate at the corner.

13. The method of claim 10, wherein creating the at least one liner die cut comprises creating two triangular die cuts positioned at opposite corners of the label substrate.

14. The method of claim 10, wherein creating the at least one liner die cut comprises creating at least one half circular die cut positioned at the center edge of the removable inner label, the at least one half circular die cut oriented with a flat edge aligned with the center edge of the removable inner label and a curved portion extending into the liner substrate beneath the removable inner label.

15. A label, comprising:
a label substrate having a front side and a backside;
a repositionable high tack adhesive flood coated on the backside of the label substrate; and
a removable inner label defined within the label substrate by a label die cut extending through a full thickness of the label substrate;
wherein the backside of the removable inner label carries a portion of the repositionable high tack adhesive such that, upon separation of the removable inner label from the label substrate, the removable inner label retains the portion of the repositionable high tack adhesive on its backside enabling the removable inner label to be adhered to a secondary surface.

16. The label of claim 15, wherein the label die cut defines a continuous closed boundary of the removable inner label within the label substrate such that the removable inner label is separable from a primary portion of the label substrate in a single peeling motion without requiring cutting tools or partial tearing of the label substrate.

17. The label of claim 15, wherein the repositionable high tack adhesive is selected to provide a peel adhesion force sufficient to maintain adhesion of the label substrate to a packaging surface under handling and environmental conditions expected during shipping and distribution, while permitting clean removal of the removable inner label from a primary portion of the label substrate without adhesive residue transfer to the primary portion of the label substrate or to the packaging surface.

18. The label of claim 15, wherein the removable inner label retains the portion of the repositionable high tack adhesive on its backside upon separation from a primary portion of the label substrate, the portion of the repositionable high tack adhesive enabling the removable inner label to be re-adhered to a secondary surface and repositioned on the secondary surface without permanent bonding.

19. The label of claim 15, wherein the label substrate is configured to be releasably adhered to a liner substrate, the liner substrate including at least one liner die cut positioned at a center edge of the removable inner label and oriented with a flat edge aligned with the center edge of the removable inner label and a curved portion extending into the liner substrate beneath the removable inner label, the at least one liner die cut providing a tactile lifting point enabling a user to initiate peeling of the removable inner label from a primary portion of the label substrate after the label substrate has been applied to a surface.

20. The label of claim 15, wherein the label substrate comprises a paper-based material, a polymeric film material, or a combination thereof, and wherein the repositionable high tack adhesive comprises a repositionable hot melt adhesive or a rubber-based acrylic adhesive.
